(19) United States
(12) Patent Application Publication
(10) Pub. No.: US 2025/0162713 A1
(43) Pub. Date: May 22, 2025

(54) Wireless Implemented Aircraft Customer Preferences and Settings

(71) Applicant: Textron Aviation Inc., Wichita, KS (US)

(72) Inventor: Michael Louis Koonce, Wichita, KS (US)

(21) Appl. No.: 18/928,736

(22) Filed: Oct. 28, 2024

Related U.S. Application Data
(60) Provisional application No. 63/601,044, filed on Nov. 20, 2023.

(51) Int. Cl. B64D 11/00; G06K 7/10

(52) U.S. Cl. CPC B64D 11/00155; G06K 7/10475

(57) ABSTRACT

A control system for implementing passenger preferences and setting in aircraft systems includes an RFID reader operable to detect and identify an RFID tag associated with a passenger boarding, or aboard, an aircraft. Information associated with the passenger is retrieved and used to effect settings of various aircraft systems according to passenger preferences, such as HVAC temperature and air flow, as well as audio, visual, and lighting. In alternative embodiments other wireless detection hardware, such as NFC is used to identify passengers and to implement preferred settings of aircraft systems.

### CROSS-REFERENCE TO RELATED APPLICATIONS

This application claims the benefit of U.S. Provisional Patent Application No. 63/601,044, filed Nov. 20, 2023, the disclosure of which is hereby incorporated herein in its entirety by reference.

### FIELD

Embodiments of the invention relate generally to aircraft settings based on customer preferences, and more specifically to customer preference and settings implemented based on wireless radio frequency identification (RFID) of a specific customer.

### BACKGROUND

Modern aircraft include numerous systems and devices to provide for the comfort and convenience of passengers. For example, heating, air-conditioning, and ventilation (HVAC) systems on the aircraft allow a passenger to set and/or adjust air temperatures and air flow as desired. Seating controls may allow a user to adjust seat height, recline, position, and lumbar support. Lighting systems allow passengers to set lighting levels in and around their seating area. And audio and video systems allow passengers to view pictures, video, movies, or other visual media and to listen to music, podcasts, ambience or noise recordings, and other aural media. Thus, once seated, customers can adjust each of the various available systems and devices to their personal preferences, with the next customer using that same seat likewise able to adjust the settings to their personal preference—i.e., undoing the settings of the previous passenger and adjusting the settings as desired. Other passenger preferences, such as preferred meals, drinks, or other amenities must be conveyed by the passenger to the attending flight crew.

While the various systems provide comfort and convenience, frequent flyer passengers, or passengers making multiple aircraft changes during a trip, must make the same adjustments over and over each time they enter an aircraft—undoing the previous customer's settings and individually resetting the various systems and devices to their own preferences.

Thus, it can be seen that there remains a need in the art for an improved system and method of allowing customers to set the various systems and devices in the aircraft according to the current customer's personal preferences.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In one embodiment, a passenger boarding an aircraft carries a wirelessly readable identification device associated with that unique passenger, such as a radio frequency identification (RFID) tag or other similar near-field communication (NFC) device or other wirelessly readable identification device. A wireless reader, such as an RFID reader, NFC reader, or other wireless reader, is integrated into a door jamb and/or into other aircraft structure adjacent ingress and egress portals of the aircraft, or along passageways within the aircraft, such as within seat structures alongside the aisle(s) within the aircraft. The RFID reader is operable to read the RFID tags of entering passengers and convey that identification to a control system having access to information associated with the RFID tag—such as passenger preferences—and convey that information to systems within the aircraft to adjust those systems according to the passenger's preferences, and to convey passenger information to the air crew regarding, for example, meal and drink preferences or other passenger information relevant to the air crew.

For example, upon entering the aircraft, a passenger may be greeted with a personalized welcome message displayed on a monitor, such as “Welcome Aboard Michael”. The system may further identify the seat assigned to that passenger and adjust the seat position, seat heating or cooling, lighting, HVAC temperature and airflow, and audio and video settings according to the passenger's preferences accessed from a data base of preference information associated with the passenger's RFID tag. In some embodiments, the system may further convey passenger preference information to the flight crew, such as meal and drink preferences (or restrictions), reading material preferences, or any other information associated with the passenger. That information may be conveyed to a monitor accessible by the flight crew, may be sent to a printer, or may be sent to a smart device such as a tablet or smart phone device used by the air crew.

The wireless information system may be integrated with any aircraft systems that would normally be operated by the passenger as long as those systems have the capability to receive setting information. Thus, depending on the systems available on a particular aircraft, the system may provide for automated settings and control for each of those systems. In preferred embodiments, the RFID system is used to make initial preference settings to the HVAC, audio, visual, etc. systems, but the passenger is free to override those initial settings as desired. In other embodiments, an RFID reader may be located near the passenger's seat—e.g., in the seatback of the seat immediately in front of the passenger's seat—to allow the passenger to scan his or her RFID tag to revert the systems to the passenger's preferred settings at any time.

In further embodiments, additional RFID readers may be positioned throughout the aircraft to provide further conveniences to the passenger. For example, an RFID reader active during flight disembarkation may detect the presence of a passenger's RFID tag and alert the flight crew of the passenger's name or alert them to retrieve a passenger's coat or other belongings.

In preferred embodiments, the RFID tag may be embedded in a card carried by the passenger, such as a membership or loyalty card, may be embedded in a key fob or similar device, or may be embedded in a passport case, wallet, or other item carried by the passenger. In some embodiments, the RFID tag may be embedded in a cell phone or cell phone case, in other embodiments a near field communication (NFC) device in the cell phone itself may communicate with the system to identify the passenger.

### BRIEF DESCRIPTION OF THE DRAWING FIGURES

Embodiments of the invention are described in detail below with reference to the attached drawing figures, wherein:

FIG. 1 illustrates an aircraft bulkhead having one or more RFID readers integrated therein positioned adjacent an aisle of the aircraft in accordance with an exemplary embodiment of the present invention.

FIG. 2 is an exemplary control system for reading RFID tags and actuating aircraft systems in response in accordance with an exemplary embodiment of the present invention.

FIG. 3 illustrates a plurality of aircraft passenger seats having audio and visual devices embedded in the headrests to provide passenger information and entertainment.

FIG. 4 illustrates an exemplary overhead console for a passenger aircraft seating areas having lighting, HVAC and associated controls.

FIG. 5 illustrates an aircraft seatback and side area having one or more embedded RFID readers.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

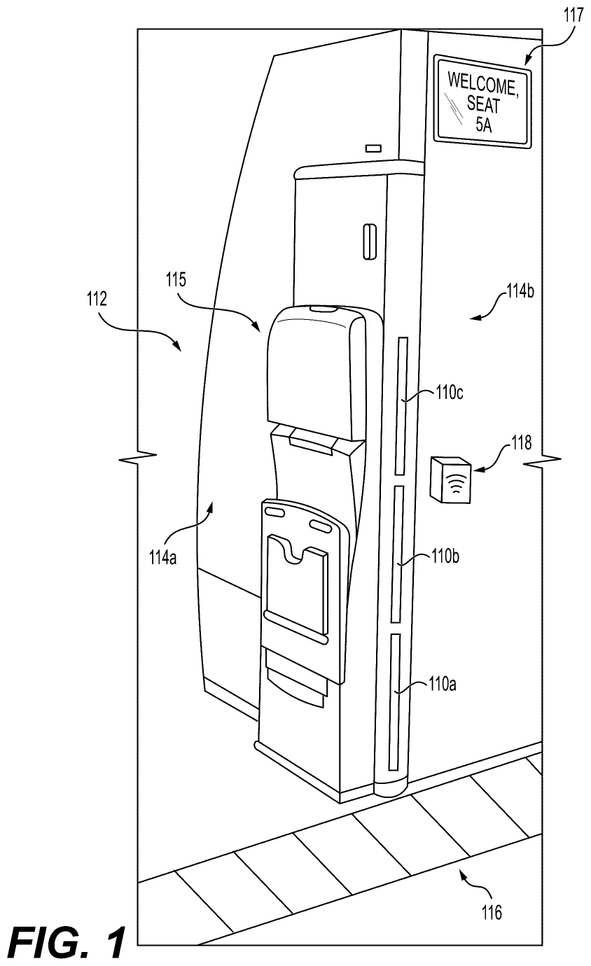

Looking first to FIG. 1, in an exemplary embodiment of the present invention, a plurality of RFID readers 110a, 110b, 110c are positioned on, or embedded within, an aircraft interior bulkhead 112. The bulkhead 112 may be a forward bulkhead located in an area where passengers typically initially enter the aircraft, such as near a forward door of the aircraft, comprising a crew-area front wall 114a and an aisle side wall 114b. As is known in the art, in addition to the RFID readers 110a, 110b, 110c, the front wall 114a may house or support other aircraft equipment, such as a fold-down jump seat 115, for use by the air crew.

The RFID readers 110a, 110b, 110c are preferably positioned adjacent an entry aisleway 116 so that entering passengers will pass by in proximity to the RFID readers as they enter the aircraft. In one embodiment, the RFID readers are positioned and are of sufficient power such that at least one of the readers can detect an RFID tag carried by the passenger-either on their person, such as an RFID tag in an identification card in a wallet, or embedded in a passport case carried by the passenger, or in their belongings carried onto the plane, such as in carryon luggage. Thus, the RFID reader(s) detect and read information associated with the boarding passenger as they pass by the RFID readers 110a, 110b, 110c.

In response to detecting and reading information from the RFID tag, a control system may use that information to actuate various settings or preferences associated with the passenger, such as preferred lighting, HVAC, or other settings at the passenger's seat, as will be described in more detail below. For example, in the embodiment depicted in FIG. 1, a monitor 117 mounted on the entryway aisle wall 114b may display a personalized “welcome” message to each entering passenger based on information associated with their RFID tag.

In an alternative embodiment as depicted in FIG. 1, an RFID tag reader may be embedded in a swipe pad device 118 positioned on or near the bulkhead 112 to allow a passenger to manually swipe a card, phone or other device having an RFID tag, NFC, or other wireless identification near the reader 118 to allow the system to read information from the RFID tag and identify the passenger and his or her flight preferences.

In one embodiment, the RFID tag may provide to the system a passenger identification number or token associated with the passenger, allowing the system to access a database to retrieve the passenger information and associated preferences. In other embodiments, the RFID tag itself may directly store the necessary information, such as the passenger's name and preference settings-without requiring access to a database of stored information. In further embodiments, the RFID tag may provide some amount of information associated with the passenger, with additional information accessible by the system from a database.

It should be understood that while the embodiments of the invention described herein use RFID tags to identify the passenger and/or to store information, other forms of identifying a passenger are within the scope of the present invention. For example, other types of near field communication (NFC) may be used to allow, for example, a passenger to use his or her cell phone to enable NFC communication with the system of the present invention. Or, the system may include a card reader device to allow a passenger to swipe or tap an identification card to allow the system to identify the passenger. These and other embodiments are anticipated by the present invention.

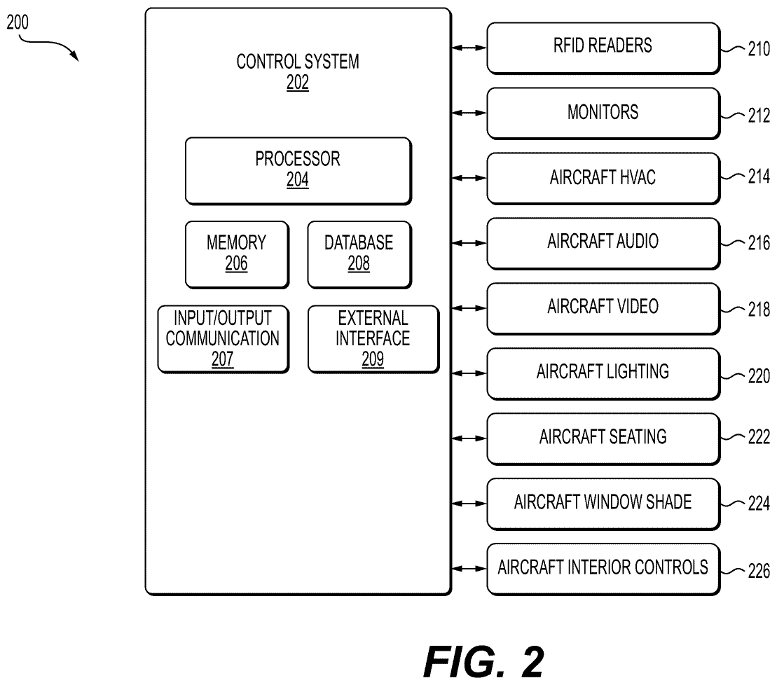

Turning to FIG. 2, a block diagram of a system for implementing passenger preferences to various aircraft systems in accordance with an exemplary embodiment of the present invention is depicted generally as 200. The system comprises a control system 202 having one or more processors 204 in communication with memory 206 and a database 208. The memory 206 includes non-transitory media having instructions stored thereon, which, when executed by the processors 204 cause the system to perform the various steps described herein, such as communicating with the RFID readers and with the various aircraft systems described herein.

The control system 202 further includes an input/output communications module 207, allowing the control system to interface with other aircraft systems (e.g., HVAC, lighting, video, audio, etc.) and an external interface module 209 which allows the control system to be attached to and communicate with external (i.e., off-aircraft) systems, such as computer systems to allow updating the database 208, software updates, or other communications.

As depicted in FIG. 2, the control system 202 is in communication with: one or more RFID readers 210 (such as the RFID readers 110a, 110b, 110c, and 118 of FIG. 1, as described above); one or more monitors 212 (such as the welcome message monitor 117 of FIG. 1); the aircraft HVAC system 214; the aircraft passenger audio system 216; the aircraft passenger video system 218; the aircraft passenger lighting system 220; the aircraft passenger seating system 222 (to adjust seat position and recline, as well as seat heating, cooling, etc.); the aircraft passenger window shade system 224; and the aircraft passenger interior controls system 226 (to control other passenger area systems and devices, such as USB port power levels).

Thus, for each passenger having an RFID tag entering the aircraft, the system reads the RFID tag using the RFID readers 210, and adjusts the aircraft systems in the passenger's seating area according to their preferences—e.g., the HVAC 214, audio 216, video 218, lightning 220, seating 222 (e.g., seat position and recline angle), window shade 224, and other interior controls 226 (e.g., USB power ports and other seating area features). And monitors 212 within the aircraft can display passenger-associated information, such as a welcome message on an entryway monitor to the entering passenger or a listing of food and beverage preferences to the aircrew on a crew station monitor.

It should be understood that in some embodiments, not all of the systems as depicted in FIG. 2 will be present—for example, a particular aircraft may not have audio 216 and video 218 at each individual seat. In such cases, the system may be tailored to control the systems that are present, or may be tailored to control systems that are present but are not specifically identified in FIG. 2.

It should be further understood that the control system 202 may include a local (i.e., on the aircraft) processor, non-transient memory, and database, and may further include a remote server, memory, and database in communication with the onboard system. Thus, in some embodiments a passenger's information may be stored at a central server, with the aircraft local system updated periodically with upcoming passenger information.

The control system 202 preferably communicates with the individual aircraft systems via hardwired or wireless communication with those individual systems. For example, in one exemplary embodiment the control system may include interface circuitry operable to tie into the aircraft wiring and to communicate with the various systems. In other embodiments, the control system 202 may communicate to each system via a wireless interface. And, in some embodiments, communication between the control system and the individual aircraft systems may be via a combination of wired and wireless communication.

External interface module 209 may include WiFi, cellular, satellite, and other communications circuitry to allow the control system to communicate with off-aircraft systems, services, and devices. For example, in some embodiments the external interface module 209 may provide access to various content providers to allow passengers to access Spotify, Netflix, Hulu, Audible, magazines, newspapers, and other media and content. In preferred embodiments, a passenger may include those external services in their preferences such that, for example, a boarding passenger's seatback video and audio display may be queued up with the latest headlines from the Wall Street Journal, and their preferred Spotify playlist ready to go.

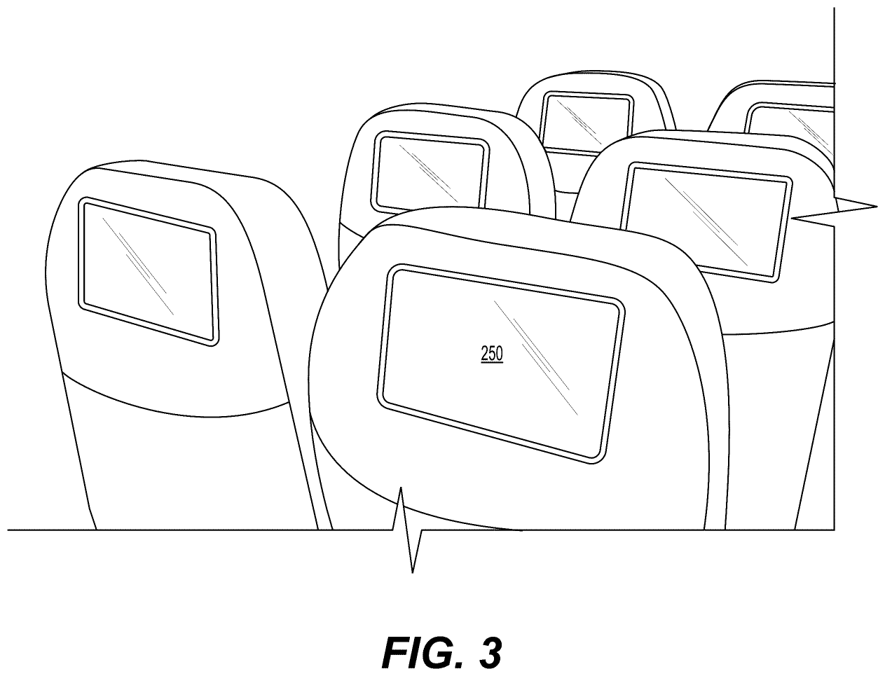

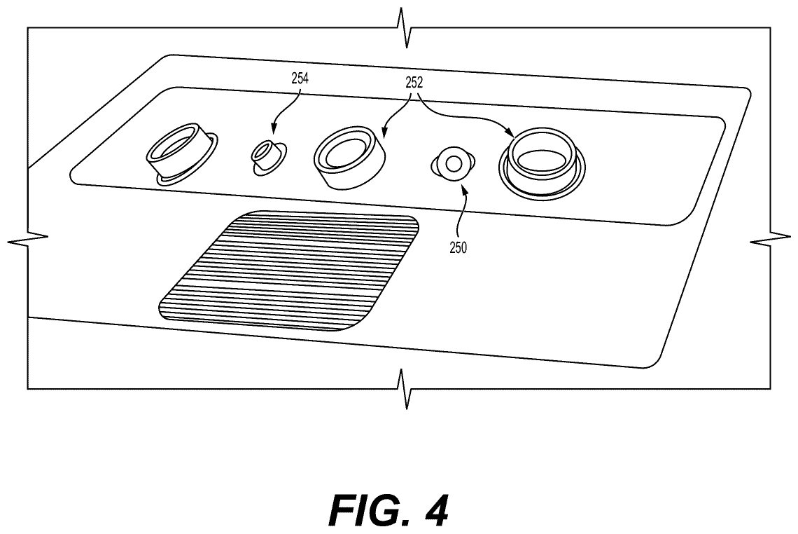

Looking to FIGS. 3 and 4, examples of aircraft systems capable of being controlled by the system of the present invention are depicted. Turning first to FIG. 3, a seatback audio and video device 250 is shown. As described above with respect to FIG. 2, the control system 202 may control aircraft audio 216 and video 218, such as audio and video device 250 as depicted in FIG. 3. As a passenger enters the aircraft and their RFID tag is scanned, the audio video system 250 at their seat may be adjusted to their preferred audio and video settings.

Similarly, looking to FIG. 4, aircraft overhead console seat area HVAC and lighting controls are depicted as numerals 252 (lighting) and 254 (HVAC). As described above with respect to FIG. 2, the control system 202 may control the aircraft HVAC 214 and aircraft lighting 220—such as the lighting 252 and HVAC 254 systems as depicted in FIG. 4. Thus, as a passenger enters the aircraft and their RFID tag is scanned, the lighting 252 and HVAC 254 systems at their seat may be adjusted to their preferred settings.

As described herein, in preferred embodiments of the present invention the controlled aircraft systems are electrically or electronically actuated, allowing the control system 202 to provide command signals to the aircraft systems to effectuate the passengers desired/preferred setting.

Preferably, the aircraft systems operated and controlled by the control system of the present invention comprise electronic controls configured to receive commands or signals from the control system to effectuate the desired settings, however the control system of the present invention may also be used with other aircraft systems having electromechanical controls. In additional embodiments the control system of the present invention may include interface circuitry and components to allow the control system to interface with existing mechanical, electromechanical, hydraulic, pneumatic, or other aircraft systems.

Thus, upon a passenger entering the aircraft and his or her RFID tag being read by an RFID reader 210, the control system 202 may retrieve passenger information and/or passenger preference information from the database 208 and communicate various information to a monitor 212, the aircraft HVAC system 214, the aircraft passenger audio system 216, the aircraft passenger video system 218, and/or the aircraft passenger lighting system 220.

For example, upon reading the RFID tag of a passenger entering the aircraft, the control system 202 may direct the display of a “welcome” message to one or more monitors 212, may set the aircraft HVAC 214 settings for the seat associated with that passenger to that passenger's preferred/desired temperature and air flow settings, may set the aircraft passenger audio system 216 to play the passenger's preferred musical playlist or other audio content, may set the aircraft passenger video system 218 to display the passenger's preferred photos, movie, or other video content, and may set the aircraft passenger lighting system 220 to a desired light level.

It should be understood that the control system may likewise make such preferred settings for every passenger boarding the aircraft so that each passenger arrives at their seat with their preferred settings already implemented in the audio, video, lighting, and HVAC systems.

It should be further understood that the control system may similarly control other aircraft systems and settings depending on the availability of such systems on the particular aircraft. For example, power seat recline and/or foot rests on aircraft with such amenities can be controlled by the system of the present invention, as can any other systems. Additionally, printers or monitors in flight crew areas may be used to provide information about the passenger(s), such as drink or meal preferences or restrictions, or other information that the passenger may wish to provide to the air crew.

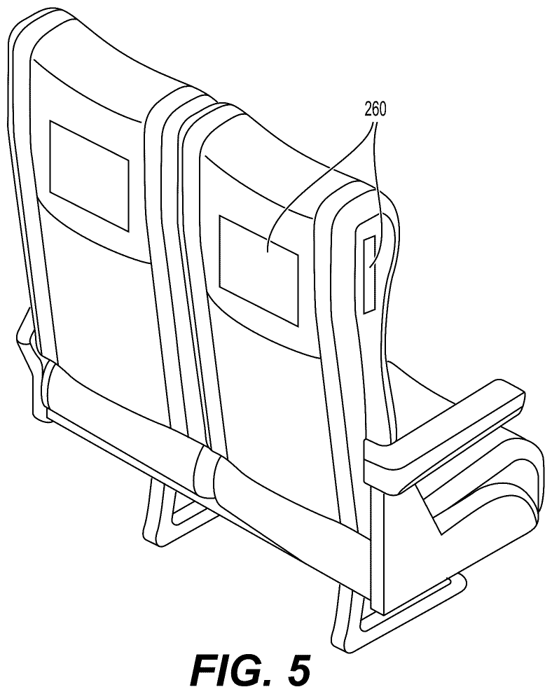

Turing to FIG. 5, in a further embodiment as depicted in FIG. 5, RFID readers 260 may be positioned or embedded within seat backs to allow detection of RFID tags at the seats and/or in the aisle of the aircraft (e.g., passing by the seat). In this embodiment, detected RFID tag information may allow the control system to detect movement of a passenger within the aircraft, such as from seat to seat, or movement up or down the aisle. Thus, the system may accommodate a passenger changing seats by transferring the passenger's preferences and settings to the newly assigned or chosen seat. Or the system may detect passengers moving up the aisle during debarkation and may, for example, alert the flight crew to retrieve a passenger's coat, suitcase, or other belongings.

As seen in FIG. 5, the RFID reader may be embedded in the side of a seatback, adjacent the aircraft aisle, to detect passengers' RFID tags (and thus their locations) as they traverse the aisle. Or, the RFID reader may be disposed within the headrest portion of the seatback, such as within or behind a video screen or tray table, to detect an RFID tag of a passenger sitting in the seat facing the seatback.

Although the invention has been described with reference to the embodiments illustrated in the attached drawing figures, it is noted that equivalents may be employed and substitutions made herein without departing from the scope of the invention as recited in the claims.

Furthermore, it should be understood that while the embodiments herein have been described in conjunction with aircraft, the invention may be similarly deployed in other vehicles in which passengers or customers enter or board, such as watercraft (i.e., waterborne vehicles such as cruise ships, yachts, tour boats, etc.), or land vehicles such as buses, recreational vehicles, sport utility vehicles, or automobiles. In such embodiments, the RFID, NFC, or other wireless readers may be deployed in appropriate vehicle structure and the controlled vehicle systems and devices will be specific to those vehicles.

Having thus described various embodiments of the invention, what is claimed as new and desired to be protected by Letters Patent includes the following:

What is claimed is:

1. A control system for aircraft passenger preference settings, comprising:
a processor in communication with a memory and a database, wherein the database comprises passenger preference information; and
one or more radio-frequency identification (RFID) readers in communication with the processor, the RFID readers operable to detect and read an RFID tag carried by a passenger and to provide information associated with the RFID tag to the processor, wherein the processor is operable to control one or more aircraft systems and adjust the aircraft systems' settings to the passenger's preferences.

2. The control system of claim 1, wherein the one or more RFID readers are attached to or embedded within an aircraft bulkhead to detect a passenger-carried RFID tag as the passenger enters the aircraft.

3. The control system of claim 1, wherein the one or more RFID readers are embedded in one or more aircraft seatbacks positioned adjacent an aircraft aisleway to detect a passenger-carried RFID tag as a passenger moves along the aisleway within the aircraft.

4. The control system of claim 1, wherein the one or more RFID readers are operable to detect an RFID tag carried by a passenger or within an article carried by a passenger.

5. The control system of claim 4, wherein the article carried by a passenger is an identification card, a wallet, a case, a suitcase, a travel bag, a phone, a phone case, or combinations thereof.

6. The control system of claim 1, wherein the identified passenger preferences include aircraft system preferred settings, seating preferences, meal preferences, drink preferences, welcome messages, information for aircraft crewmembers, or combinations thereof.

7. The control system of claim 6, wherein passenger preferences may be displayed on seat mounted displays, bulkhead mounted displays, air crew accessible displays or printers, or combinations thereof.

8. A control system for aircraft passenger preference settings, comprising:
a processor in communication with a memory and a database, wherein the database comprises passenger preference information and wherein the memory comprises instructions, that when executed by the processor, cause the control system to:
communicate with one or more wireless identification readers operable to detect and communicate with a wireless identification device carried by a passenger;
retrieve preference information associated with the passenger from the database; and
communicate with one or more aircraft systems to adjust the settings of those systems in accordance with the passenger's preferences.

9. The control system of claim 8, wherein the wireless identification readers comprise RFID readers.

10. The control system of claim 8, wherein the wireless identification readers are attached to or embedded within an aircraft bulkhead to detect a passenger-carried wireless identification device as the passenger enters the aircraft.

11. The control system of claim 8, wherein the wireless identification readers are embedded in one or more aircraft seatbacks positioned adjacent an aircraft aisleway.

12. The control system of claim 8, wherein the wireless identification device carried by a passenger is embedded in an identification card, a wallet, a case, a suitcase, a travel bag, a phone, a phone case, or combinations thereof.

13. The control system of claim 8, wherein the identified passenger preferences include aircraft system preferred settings, seating preferences, meal preferences, drink preferences, welcome messages, information for aircraft crewmembers, or combinations thereof.

14. The control system of claim 13, wherein passenger preferences may be displayed on seat mounted displays, bulkhead mounted displays, air crew accessible displays or printers, or combinations thereof.

15. A control system for aircraft passenger preference settings, comprising:
a processor in communication with a memory and a database, wherein the database comprises passenger preference information; and
a plurality of radio-frequency identification (RFID) readers in communication with the processor, the RFID readers operable to detect and read an RFID tag carried by a passenger and to provide information associated with the RFID tag to the processor; and
wherein the processor is operable retrieve information associated with the RFID tag to control one or more aircraft systems to adjust the aircraft systems' settings to the passenger's preferences.

16. The control system of claim 15, wherein the one or more RFID readers are attached to or embedded within an aircraft bulkhead to detect a passenger-carried RFID tag as the passenger enters the aircraft.

17. The control system of claim 15, wherein the one or more RFID readers are embedded in one or more aircraft seatbacks positioned adjacent an aircraft aisleway to detect a passenger-carried RFID tag as a passenger moves along the aisleway within the aircraft.

18. The control system of claim 4, wherein the article carried by a passenger is an identification card, a wallet, a case, a suitcase, a travel bag, a phone, a phone case, or combinations thereof.

19. The control system of claim 15, wherein the identified passenger preferences include aircraft system preferred settings, seating preferences, meal preferences, drink preferences, welcome messages, information for aircraft crew members, or combinations thereof.
